(19) United States
(12) Patent Application Publication
(10) Pub. No.: US 2011/0140915 A1
(43) Pub. Date: Jun. 16, 2011

(54) Distributed Personalized Energy and Carbon Accounting and Feedback System

(75) Inventors: Roger F. Buelow, II, Gate Mills, OH (US); Laszlo A. Takacs, Lakewood, OH (US); Christopher H. Jenson, Twinsburg, OH (US); Keith Kazenski, Twinsburg, OH (US)

(73) Assignee: Energy Focus, Inc., Solon, OH (US)

(21) Appl. No.: 12/904,847

(22) Filed: Oct. 14, 2010

Related U.S. Application Data
(60) Provisional application No. 61/251,331, filed on Oct. 14, 2009.

(51) Int. Cl. G08B 21/00; G08C 19/22

(52) U.S. Cl. 340/870.09; 340/870.07

(57) ABSTRACT

Disclosed is a system for providing personalized energy usage feedback. The system comprises an arrangement to determine respective energy-usage of a specific person for each of a plurality of energy-consuming devices. The foregoing arrangement comprises power-usage sensors for the plurality of energy-consuming devices, an allocation arrangement for determining an estimated or measured allocation of power for each energy-consuming device that is attributable to the specific person, and an arrangement for determining the length of time of power usage that is attributable to the specific person. A feedback arrangement provides feedback to the specific person of all or a subset of the respective energy-usage attributable to that person.

### FIELD OF THE INVENTION

The present invention relates to a system for monitoring energy or carbon usage of one or more specific persons, and for providing personalized feedback of such usage.

### BACKGROUND OF THE INVENTION

Tracking of energy usage is customarily done for an energy-consuming device or devices by using meters to monitor the use of electrical, gas, oil and other energy sources. These meters are typically used to monitor a relatively large area, such as a home, an apartment, or commercial or non-commercial buildings. These meters measure an aggregate usage of energy and are very useful for determining overall trends of energy usage.

Current methods of monitoring energy consumption do not provide monitoring of the energy or carbon usage attributable to a “specific” person, by which is meant a unique person. Accordingly, it would be desirable to provide a system that monitors the energy or carbon usage of one or more specific persons, and that provides feedback to the one or more specific persons or to others.

By way of definitions of various terms used in this specification, energy usage can be expressed in terms of carbon usage. In particular, energy usage relates to carbon consumption and subsequent carbon dioxide generation. Energy is usually derived from solar, hydrocarbons, nuclear, geothermal, hydro-power, wind and other natural sources. Once a power plant using one of the foregoing energy sources has been built, not all of them consume carbon; however, the current predominant energy source, hydrocarbons, does utilize carbon and creates carbon dioxide. Energy usage can be converted to an equivalent electrical energy usage, which in turn can be converted to a carbon equivalent usage. The United States Department of Energy provides conversions for electricity to carbon equivalents. In any event, the conversion from energy to carbon usage should take into account the fact that some forms of energy generation are relatively clean, such as hydroelectric and solar. Typically, however, the electrical energy distribution grids in any given area will make use of both “clean” and less clean electrical-generation methods. For a given grid, the percentage of clean and less clean sources are known and can be factored into the calculation of carbon usage by a specific person.

### BRIEF SUMMARY OF THE INVENTION

The invention, in a preferred form, is a system for providing personalized energy usage feedback. The system comprises means to determine respective energy-usage of a specific person for each of a plurality of energy-consuming devices. The foregoing means comprise power-usage sensors for the plurality of energy-consuming devices, allocation means for determining an estimated or measured allocation of power for each energy-consuming device that is attributable to the specific person, and means for determining the length of time of power usage that is attributable to the specific person. A feedback means provides feedback to the specific person of all or a subset of the respective energy-usage attributable to that person.

The foregoing invention provides a way to inform a specific individual of their respective energy or carbon usage, and to thereby empower that person to make conscious, and preferably real time, energy use choices that can reduce their energy or carbon use and therefor reduce what is popularly referred to as a “carbon footprint.”

Other advantages of the invention will become apparent from the remainder of this specification.

### BRIEF DESCRIPTION OF THE DRAWINGS

In the following drawings, like reference numbers refer to like parts:

FIG. 1 is a block diagram representation of a system for providing personalized energy or carbon usage feedback according to the invention.

FIG. 2 is series of feedback images provided on the screen of a device, including a tree in different states of health.

FIG. 3 is series of feedback images provided on the screen of a device, including a flower in different states of health.

FIG. 4 is series of feedback images provided on the screen of a device, including fish in an aquarium in different states of aggregate health.

FIG. 5 is a series of feedback images provided on the screen of a device, including footprints that vary in size to indicate different carbon usages (or “carbon footprints”).

FIG. 6 is a series of feedback images provided on the screen of a device, including background colors on a screen that change to indicate different amounts of energy or carbon usage.

FIG. 7 is a feedback image used as a screen image that is background for a foreground textual or graphical image.

### DETAILED DESCRIPTION OF THE PREFERRED EMBODIMENT

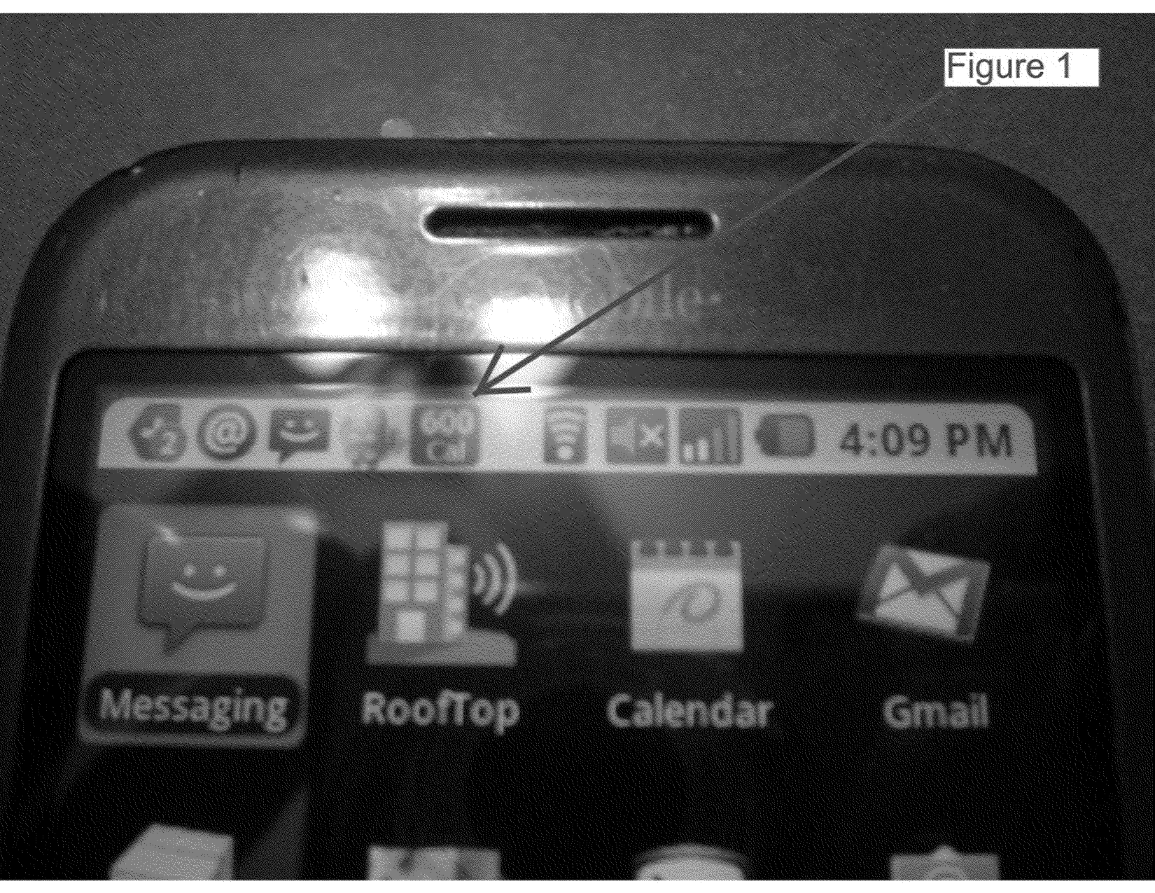

FIG. 1 shows a system 10 for providing personalized energy, and preferably carbon usage; feedback of a specific person to that person, to motivate that person through personal shame or guilt, or through the positive reinforcement provided by the feedback, to reduce energy or carbon usage. Preferably, system 10 also provides such feedback to other persons for the purpose of inducing the specific person to reduce energy or carbon usage as a result of public shame or guilt associated with a large energy or carbon usage, or as a result of the positive reinforcement provided by the feedback. Preferably, such feedback will inspire competition among different persons to reduce their energy or carbon usage.

A belief by the present inventors is that a specific (i.e., unique) person will be more motivated through the personal guilt or shame or positive reinforcement factors mentioned in the previous paragraph to reduce energy or carbon usage if that person has clear feedback concerning their energy- or carbon-usage decisions. A still further belief of the present inventors is that publicizing the energy or carbon usage feedback of a specific person to other persons, such as to co-workers or superiors in a company employing that person, will motivate the person to reduce energy or carbon usage whenever possible owing to the factors mentioned in the previous paragraph regarding public guilt or shame or positive reinforcement.

For ease of description, the further references to motivations for reducing energy or carbon usage will only refer to motivations based on guilt or shame. However, this should be considered as a shortened way to refer to motivations also based on the positive reinforcement factors resulting from feedback that are mentioned in the foregoing two paragraphs.

### Monitoring Energy or Carbon Usage of Specific Persons

The system 10 of FIG. 1 is applicable to many environments, such as a room in the building of a company that employs the person, or a room in the home of such person. To implement system 10, a digital computer 12 receives various data from various data sources 14 for the specific person, performs various functions on that data to be described below, and then provides various feedback outputs 30 for implementing the feedback function of the invention for the specific person. Preferably, system 10 also includes data sources 40 for a second specific person, further data sources as indicated by an ellipsis, and data sources 42 for the last specific person. The foregoing data sources 40, 42, etc., may be the same as data sources 14, described below, although they may share a power monitor or other components. Accompanying data sources 40, 42, etc., are respectively corresponding second person feedback outputs 44, further feedback outputs as indicated by an ellipsis, and last person feedback outputs 46. These feedback outputs may be the same as the feedback outputs 30 for the first specific people, which are described below.

Persons or ordinary skill in the art will find it routine to provide the necessary programming and, optionally, hardware or firmware design, to implement the functions described below.

With regard to data sources 14 for the first specific person when used in a room of a building of a company in which such specific person is employed, a specific person sensor 16 determines whether the specific person occupies the room. Many ways of determining the presence of a person in a room will be routine to those of ordinary skill in the art, such as the person wearing a radio-frequency identification (RFID) tag or a bar code that is sensed, facial recognition or other biometric recognition techniques such as fingerprint or retinal scans, height and weight measurements at the entrance and exits of a room, or the use of a cell phone that provides a global positioning (GPS) signal to a cell phone tower, any of which may be used in conjunction with motion sensors. For instance, various of the foregoing sensing systems could be remain dormant—and therefore use very little or no energy—until a motion sensor detects that a person is entering a room.

The digital computer 12 may also receive user preferences for use of various energy sources, for instance, as indicated by block 18. Such preferences may be for the amount of light needed by the specific person, a tolerable temperature of the room, etc. User preferences may advantageously include a user-selected limit on energy or carbon usage for all or some subset of energy-consuming devices or goods or services, the exceeding of which will trigger an alarm that is fed back to the specific person. As used herein, “goods” are intended to broadly encompass buildings, fixtures and real estate, in addition to more traditional definitions of “goods” as used in the contracts.

A light-use sensor 20 determines how much power is being used by the specific person in connection with a respective energy-consuming lighting device, or how much power is being used by multiple persons in connection with the foregoing lighting device, if there are one or more other persons in the room.

When there are multiple persons who use a room, the digital computer 12 will preferably determine the last person to leave the room. The digital computer 12 will preferably allocate continued energy usage for one or more energy-consuming devices to that person if that person has the capacity to turn off said one or more energy-consuming devices before leaving the room, and has failed to do so. Such an allocation can be achieved in routine manner with an algorithm-processing structure 19 associated with digital computer 12. Algorithm-processing structure 19 may be realized by software programming of digital computer 12, or by firmware, by way of example.

A sensor 22 senses energy use from a heater-ventilation-air conditioning (HVAC) unit, by way of example, and provides energy-use data to the computer 12. As with the light-use sensor 22, the computer 12 preferably allocates energy usage to a specific person in the same manner as described above. This is also preferably true for other sensors, indicated by block 24, which may relate to energy-consuming devices such as audio-visual or computer equipment, a microwave oven or other appliances, by way of example.

The digital computer 12 will preferably have an internal clock or clocks to measure the length of time that the specific person uses each respective energy device. The product of power usage (e.g., watts) and duration of use provides a measure of energy usage, expressed, for instance, in kilowatt-hours.

Sensors 20, 22 and 24 all relate to power usage, as indicated by the French bracket for these sensors in FIG. 1. Additionally, digital computer 12 preferably also receives data relating to carbon usage from the temporary or permanent acquisition of goods or services, as indicated by block 26. Different goods and services are associated with different usages of carbon. The same good or service also may be associated with different carbon usages, because, for instance, one vendor may exclusively rely on renewable energy sources in producing the good or service, whereas another vendor may rely on energy sources associated with high carbon usage.

Although the various data sources 14 are shown with simple arrows connected to digital computer 12, the connections may be realized as one or more computer networks; as will be routine to persons of ordinary skill in the art.

The digital computer 12 will determine energy usage, and preferably carbon usage, for the specific person, and provide to that person feedback of that person's respective energy, and preferably, carbon usage. It is preferred that the feedback be in real time, so as to motivate the person to make appropriate decisions to reduce energy or carbon usage while these decisions are being made.

As mentioned above, energy usage can also be expressed in terms of carbon usage, whereby feedback of energy usage in terms of carbon usage is considered to be equivalent to feedback of energy usage.

With regard to the feedback outputs 30 for the first specific person, FIG. 1 shows a wireless feedback arrangement 32, in which a wireless transmitter 34 provides a wireless signal to a wireless receiver 36. The wireless receiver 36 may be implemented in numerous ways, as will be apparent to persons of ordinary skill in the art, such as by a so-called “smartphone” (e.g., Blackberry- or iPhone-brand phone), personal digital assistant or iPad-brand device, or a smart badge that may be worn by the specific person and other persons in the company employing such person.

Non-wireless feedback may be provided, as indicated in block 38, to computers, or wired phones, etc., and can be in any convenient form, such as graphical, textual, email, or audio.

Although FIG. 1 shows wireless feedback arrangement 32 and block 38 for non-wireless feedback arrangements with simple arrows originating from computer 12, these feedback arrangements may be interconnected with the computer via one or more networks, as will be routine to persons of ordinary skill in the art.

In addition to the wireless and non-wireless feedback arrangements 32 and 38 just described for the first specific person and the other outputs 44, 46, etc., for other specific persons, other access to the feedback data compiled in computer 12 is shown by a block 48. The arrow connecting block 48 to computer 12 has two arrowheads. The use of two arrowheads is meant to convey that an interested person or company can query the data compiled in computer 12, as might be desirable for a specific person who does not use one the more automated feedback outputs 30, 44, 46, etc., but who can access and query the data via a website, for instance. Beneficially, a bill payer, chief financial officer or other concerned person at a company can use the other access 48 by querying to learn which specific person consumes the most energy with a specific energy-consuming device or uses the most carbon with respect to temporary or permanent acquisition of goods or service. This will enable the company to consult with the responsible specific person, for instance, to counsel the person on how to reduce their energy or carbon usage. The company can also use comparative energy or carbon usage data to host competitions by providing special recognition to a person who achieves the least energy or carbon usage, or who exhibits the greatest reduction in energy or carbon usage. Other access 48 can also be used, for instance, by a public utility that supplies energy to learn of energy-usage patterns for the specific person, or for all specific persons whose energy or carbon usage is being monitored, by querying the data compiled in digital computer 12. Rather than querying for data, as mentioned earlier in several instances in this paragraph, a preprogrammed algorithm, implemented by algorithm-processing structure 19, could be used to provide the desired information.

Whereas digital computer 12 is shown in a single rectangle, it may in fact be comprised of different central processing units and different temporary or long-term data storage devices which cooperate together, and may be distributed in one or more computer networks.

### Public Shame or Guilt as Motivator to Reduce Energy or Carbon Usage

Feedback outputs 30, 44 and 46 of FIG. 1 may optionally be provided to persons in addition to the specific person whose energy or carbon usage is being monitored, such as to co-workers and superiors in a building used by a company. In this manner, public shame or guilt associated with a large energy or carbon usage will motivate the specific person to reduce their energy or carbon usage.

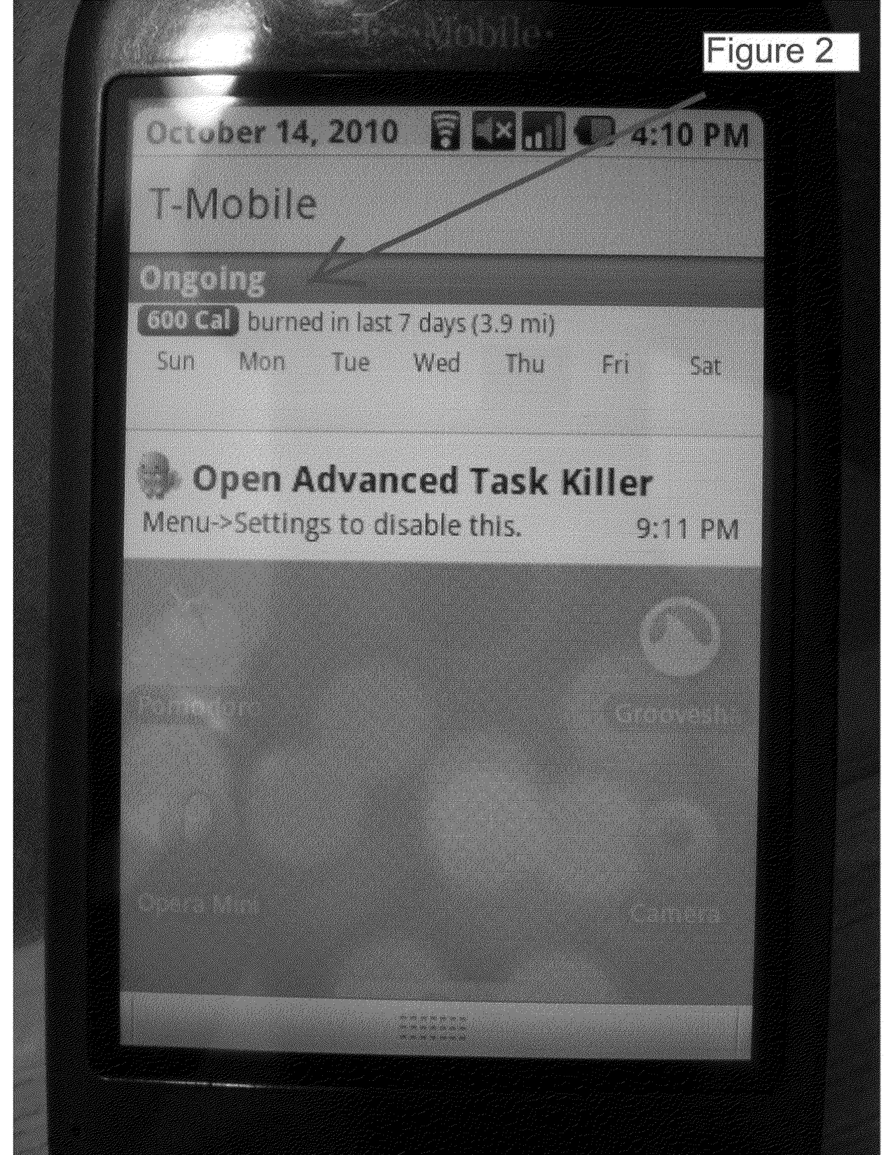

In order for a specific person to be publicly shamed, or feel guilty, about poor choices concerning energy or carbon usage, the feedback of such usage should be, preferably, clearly and quickly apparent to other persons. Thus, FIG. 2 shows a possible sequence of screen images 54a-54c on a device 56, which may be a smartphone, or other wireless device, or a non-wireless device such as a computer or wired phone, by way of example. These images and the other images shown in the drawings may be viewable on publicly available computer or television screens, for instance. Screen image 54a shows an image of a tree that is healthy, indicating good energy or carbon usage decisions; screen 54b shows an image of the tree that tis less healthy, with a substantial number of its branches and leaves fallen to the ground; and screen 54c shows an image of the tree that is clearly not very healthy, with all or almost all of its branches and leaves fallen to the ground. Images 54a-54c thus progressively show less healthy images as more energy or carbon is used by the person, indicating that the person is making less than healthy environmental choices. Such a progression of less healthy images as the person is using more energy or carbon is a theme that carries through FIGS. 2-5.

For simplicity of illustration, in FIG. 2, only images 54a, 54b and 54c are shown. However, there is preferably a continuum of many images between that of images 54a and 54c, whereby, for instance, between image 54a and 54b are images in which some branches and leaves of the tree has fallen off, but not so many as in image 54b.

In order to more be more easily understood by persons other than the associated specific person, all images 54a-54c preferably dynamically change at least every five seconds, and preferably change in a shorter amount of time, such as three or two seconds, and more preferably change continuously. This will provide an image which both attracts the attention of other persons and more intuitively identifies itself as an image of a tree. Thus, screen 54a indicates motion of the leaves of the tree shown, as might happen when a breeze of air flows through through the tree. Screens 54b and 54c each show a branch of the tree in phantom and that branch falling to the ground. In the actual respective scenes, a branch repeatedly falls to the ground, then appears as restored to the tree, and again falls. Other ways to show motion than as just described will be apparent to persons of ordinary skill in the art.

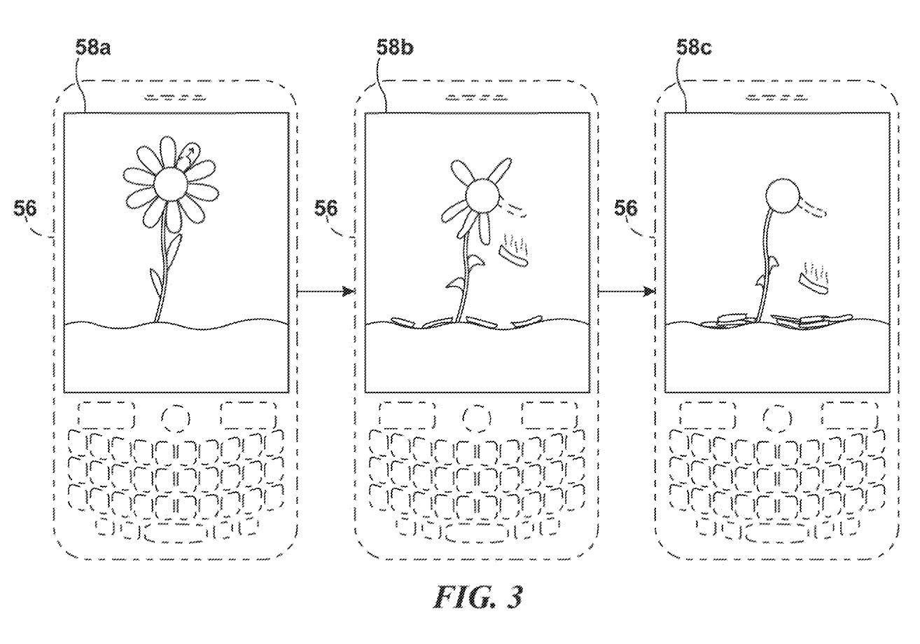

FIG. 3 is similar to FIG. 2, and the above description of FIG. 2 is therefore largely applicable, except insofar that a flower and its petals are shown in screen images 58a-58c of FIG. 3 rather than a tree and its branches and leaves as in FIG. 2. One difference is that the flower in image 58a (FIG. 3) indicates motion by continually growing a petal, whereas the tree in image indicates motion by swaying in the wind.

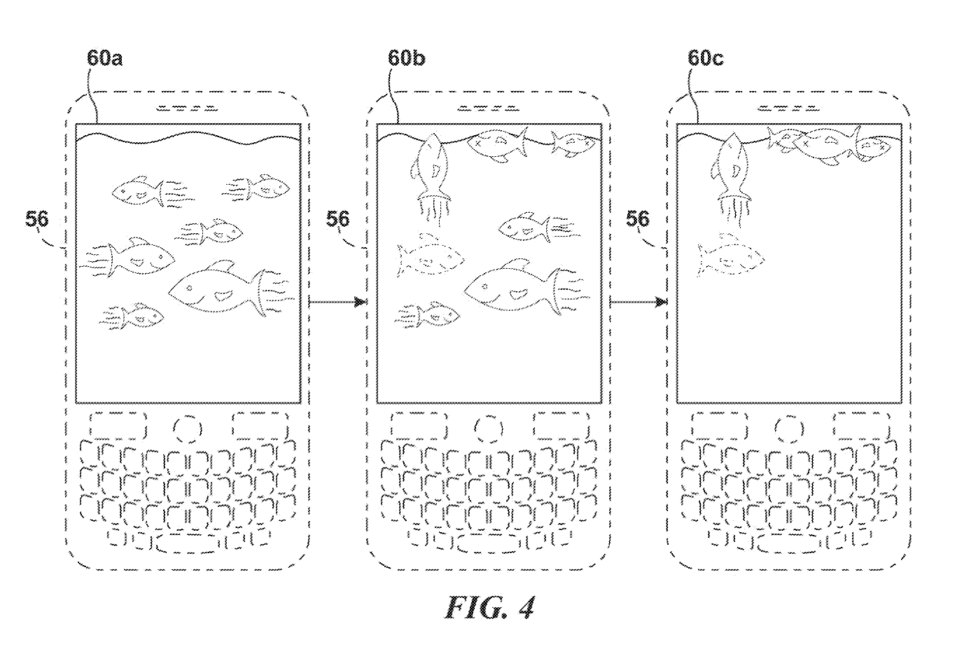

Rather than show flora in different states of health as in FIGS. 2 and 3, FIG. 4 shows fauna (i.e., fish) in water in different states of aggregate health. When more fish are shown living, the aggregate health of all the fish is better than when more of the fish are shown dead. As with FIGS. 2-3, the images of FIG. 4 show only select ones of different sequential views, and respective continuums of views would appear between the times of the specific images shown, to indicate different amounts of energy or carbon usage. To convey a dynamically changing image for the same aggregate health, the fish in screen image 60a are shown moving (e.g., swimming); and one fish in screen images 60b and 60c is shown in phantom in a healthy state and is also shown moving upwardly in an unhealthy (i.e., dead) state. In the actual respective scenes images 60b and 60c, the fish shown in phantom repeatedly dies and floats to the top of the water, then appears as restored to life, and again dies and floats to the top of the water. Other ways to show motion than as just described will be apparent to persons of ordinary skill in the art.

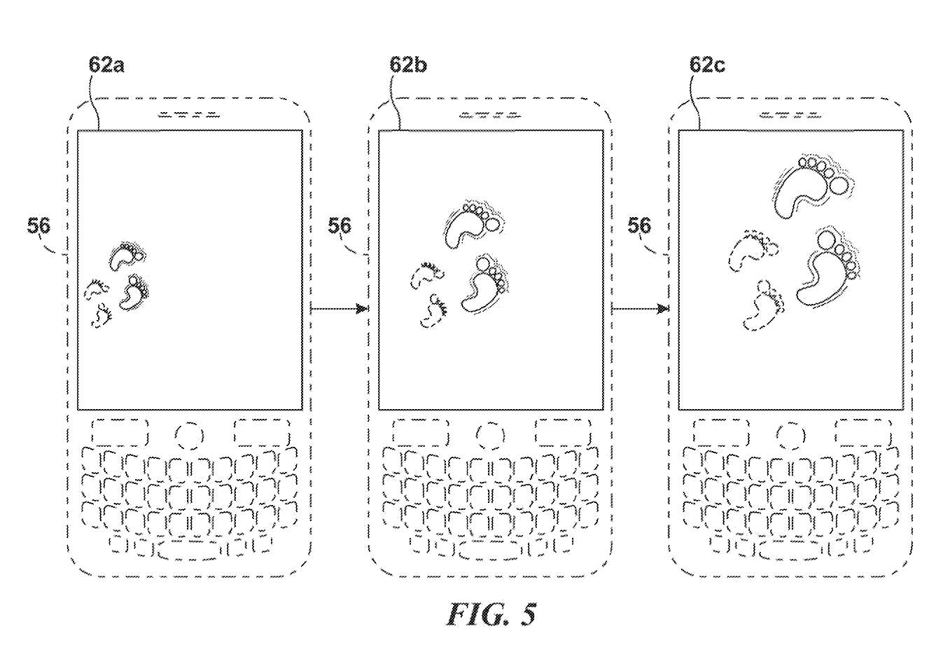

FIG. 5 shows a series of screen images 62a, 62b and 62c of footprints that vary in size to indicate increasing usage of energy or carbon. As with FIGS. 2-4, the images of FIG. 5 show only select ones of different sequential views, and respective continuums of views would appear between the times of the specific images shown, to indicate different amounts of carbon usage. While energy carbon usage is constant, movement of footsteps is illustrated by showing a pair of footsteps in phantom, followed by a pair of footsteps in full and an indication of movement. In an actual scene, a pair of footsteps progressively make their way from one side of the screen to the other.

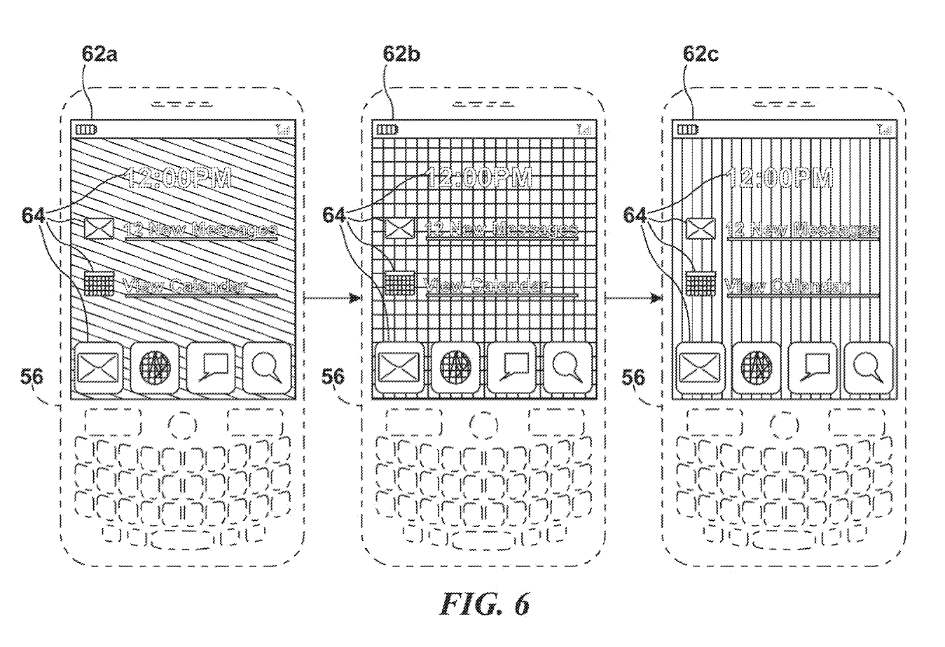

Another way to visually indicate the energy or carbon usage of a specific person is to provide different background colors, as illustrated in FIG. 6. Thus, screen images 62a, 62b and 62c respectively show, by different hatchings, background colors of green, yellow and red, to indicate good, less good and poor energy or carbon usage. Although the entire background of each screen is shown with a single color, only some part of a screen might exhibit the background color, and the background color need not be perfectly homogeneous. For instance, different shades of green, yellow and red might be simultaneously used in screen images 62a, 62b and 62c, respectively. As can be seen in each image 62a-62b, text or icons 64 shown in phantom are provided in the foreground, as typically may appear as the default screen in a smartphone or desktop computer. In this manner, the screen images 62a-62c may be conveniently provided on a smartphone or desktop computer, for instance, with minimal programming and preferably no need to change the basic operation of the device.

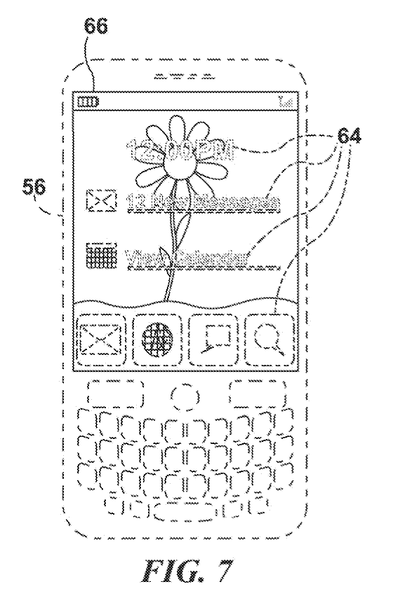

As shown in FIG. 7, any of the screen images shown in FIGS. 2-5 can also be a background image which is displayed in combination with text or icons 64. FIG. 7 shows, as an exemplary background, image 58a of FIG. 3.

The various screen images of the foregoing FIGS. 2-5 are particularly adapted for being quick and easy for persons other than the specific person—i.e., members of some segment of the public—to understand. It is, of course, intended that the specific person will also see this type of feedback.

One type of feedback about which the specific person may be highly interested would be the setting of a limit, via user preferences 18 of FIG. 1, on energy or carbon usage for all or some subset of energy-consuming devices or goods or services. The exceeding of, of trending in a way so as to exceed, such a limit can then, using algorithm-processing structure 19 of FIG. 1, trigger an alarm that is fed back to the specific person. One way to implement the trigger is to periodically turn on and turn off the display of any of the screen images of FIGS. 2-5, for instance. The resulting flashing of any of the images would be very attention provoking, and could therefore suitably serve as an alarm.

Many types of screen images can be used with the current invention other than as illustrated herein. For instance, a bar graph (not shown) with a single bar could be shown, and the length of the bar could vary with the value of the number displayed, For instance, the numbers displayed could range from 0 to 100. The higher numbers (e.g., 100) could indicate high energy or carbon usage, and the bar for such a higher number could assume a red color, for instance, to indicate high energy or carbon usage. With this color scheme, a green color could indicate low energy or carbon usage, and a yellow color could indicate medium energy or carbon usage, by way of example. Further, the number displayed, and corresponding length of the bar, could indicate total energy or carbon used in a day, or the instantaneous rate of such usage, or some cumulative measure of such usage that could even extend back to the beginning of a person's life, probably based on an estimate. As an alternative to the foregoing display of a number on a bar graph, a constantly changing number related to ongoing energy or carbon usage could be displayed on a bar graph. The constantly changing numbers would be attention provoking.

### Feedback for Aggregate or Subset of Energy or Carbon Usage

The various feedback screen images described in connection with FIGS. 2-7 can provide feedback for the aggregate energy or carbon usage of a specific person. However, there are circumstances in which it would be desirable to provide feedback for a subset of the energy or carbon usage, such as when the specific person has a relatively higher ability to reduce energy or carbon usage over the subset of energy-consuming devices or goods and services than over other devices or goods or services outside of the subset. The subset could be a single energy-consuming device or good or service. Thus, digital computer 12 of FIG. 1 may use algorithm-processing structure 19 of FIG. 1 to make the foregoing determination.

The foregoing describes a system for personalized energy usage feedback, which informs one or more specific persons and others of their respective energy or carbon usage. This empowers the one or more persons to make conscious, and preferably real time, energy use choices that can reduce their energy or carbon use, or “carbon footprint,” and enables public shame and guilt to further motivate such persons to reduce their carbon footprint.

While the invention has been described with respect to specific embodiments by way of illustration, many modifications and changes will occur to those skilled in the art. It is, therefore, to be understood that the appended claims are intended to cover all such modifications and changes as fall within the true scope and spirit of the invention.

What is claimed is:

1. A system for providing personalized energy usage feedback, comprising:
a) means to determine respective energy-usage of a specific person for each of a plurality of energy-consuming devices, comprising:
i) power-usage sensors for said plurality of energy-consuming devices;
ii) allocation means for determining an estimated or measured allocation of power for each energy-consuming device that is attributable to said specific person; and
iii) means for determining the length of time of power usage that is attributable to said specific person; and
b) feedback means for providing feedback to said specific person of all or a subset of said respective energy-usage attributable to that person.

2. The system of claim 1, wherein the feedback is provided in real time.

3. The system of claim 1, wherein the feedback includes means for providing feedback to the specific individual of their aggregate energy-usage from said plurality of energy-consuming devices.

4. The system of claim 1, wherein the feedback includes means for providing feedback to the specific individual of their total energy-usage from a subset of said plurality of energy-consuming devices in the event that an algorithm-processing structure determines that said specific person has a relatively higher ability to reduce energy or carbon usage than with energy sources not contained within the subset.

5. The system of claim 1, wherein the feedback on energy usage is expressed in terms of carbon usage.

6. The system of claim 1, wherein the allocation means includes:
a) means determine the last person to leave an area that can use one or more energy-consuming devices; and
b) means to allocate continued energy usage for said one or more energy-consuming devices to that person if that person has failed to turn off said one or more energy-consuming devices.

7. The system of claim 1, further comprising:
a) means to determine carbon-usage of said specific person, comprising:
i) sensors for quantifying carbon usage associated with acquisition of products or services to be used at least in part by said specific individual;
ii) means to allocate carbon usage for each of said products or services to said specific individual; and
iii) means to determine respective carbon usage allocable to said specific person for each of said products or service; and
b) means for providing feedback to said specific individual of said respective carbon usage.

8. The system of claim 1, wherein the feedback means provides a graphical image that evolves to show good or poor choices regarding energy or carbon usage.

9. The system of claim 8, wherein the image is of flora or fauna that are shown in a more healthy state and a less healthy state to respectively indicate good and poor choices regarding energy or carbon usage.

10. The system of claim 8, wherein the image dynamically changes at least every five seconds even with the same level of health of the flora or fauna.

11. The system of claim 9, wherein the image continuously changes dynamically even with the same level of health of the flora or fauna.

12. The system of claim 9, wherein the image is a depiction of at least one tree or a flower.

13. The system of claim 9, wherein the image is a depiction of fish in a body of water.

14. The system of claim 8, wherein the image is that of a symbol whose size grows to indicate increasing energy or carbon usage and whose size shrinks to indicate decreasing energy or carbon usage.

15. The system of claim 14, wherein the symbol is that of a human footprint.

16. The system of claim 8, wherein:
a) said image is shown on a screen that is viewable by said specific person;
b) the screen has a background color or colors and also foregoing graphical or textual content; and
c) said image that evolves is that of the background color.

17. The system of claim 1, wherein the feedback means includes means for alerting the user to a respective energy usage exceeding, or trending in a way so as to exceed, a predetermined limit.

18. The system of claim 17, wherein the feedback is provided in real time.

19. The system of claim 1, wherein the feedback means includes means to publicly display the energy or carbon usage of the individual.

20. The system of claim 19, wherein the means to publicly display is a display intended to be worn on said specific person so as to publicly display an indication of the energy or carbon usage of the individual.

21. The system of claim 19, wherein the means to publicly display is a display shown on a publicly viewable screen in a building in which said specific person is located.

22. The system of claim 1, further comprising:
a) means to determine respective energy-usages of a plurality of additional specific persons for each of a plurality of energy-consuming devices, comprising, for each additional specific person:
i) power-usage sensors for said plurality of energy-consuming devices;
ii) allocation means for determining an estimated or measured allocation of power for each energy-consuming device that is attributable to said each additional specific person; and
iii) means for determining the length of time of power usage that is attributable to said each additional specific person; and
b) comparison means for determining comparative energy or carbon usage as between different specific persons.

23. The system of claim 22, wherein the comparison means includes means to determine aggregate energy or carbon usage as between different specific persons.

24. The system of claim 22, wherein the comparison means includes means to determine which specific person uses the most energy or carbon with respect to a single energy-consuming device or good or service and how much more energy or carbon usage occurs than with other specific persons.
